(19) United States
(12) Patent Application Publication
(10) Pub. No.: US 2024/0256142 A1
(43) Pub. Date: Aug. 1, 2024

(54) MANAGING PARTIALLY PROGRAMMED BLOCKS

(71) Applicant: Micron Technology, Inc., Boise, ID (US)

(72) Inventors: Chun Sum Yeung, San Jose, CA (US); Pitamber Shukla, San Jose, CA (US); Zhongyuan Lu, Boise, ID (US); Niccolo' Righetti, Boise, ID (US)

(21) Appl. No.: 18/420,491

(22) Filed: Jan. 23, 2024

Related U.S. Application Data
(60) Provisional application No. 63/442,683, filed on Feb. 1, 2023.

(51) Int. Cl. G06F 3/06

(52) U.S. Cl. CPC G06F 3/0613; G06F 3/064; G06F 3/0679

(57) ABSTRACT

Methods, systems, and devices for managing partially programmed blocks are described. Based on writing data stored in a first block to a second block, a determination of whether to program the first block into a fully programmed state may be made based on whether the first block is storing the data in the partially programmed state. Based on determining whether to program the first block, the first block may be maintained in the fully programmed state until an erase operation is performed for the first block.

### CROSS REFERENCE

The present application for patent claims the benefit of U.S. Provisional Patent Application No. 63/442,683 by YEUNG et al., entitled “MANAGING PARTIALLY PROGRAMMED BLOCKS,” filed Feb. 1, 2023, assigned to the assignee hereof, and expressly incorporated by reference in its entirety herein.

### TECHNICAL FIELD

The following relates to one or more systems for memory, including managing partially programmed blocks.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 illustrates an example of a system that supports managing partially programmed blocks in accordance with examples as disclosed herein.

FIG. 2 illustrates an example of a set of operations for managing partially programmed blocks in accordance with examples as disclosed herein.

FIG. 3 illustrates an example of a diagram associated with managing partially programmed blocks in accordance with examples as disclosed herein.

FIG. 4 illustrates a block diagram of a memory system that supports managing partially programmed blocks in accordance with examples as disclosed herein.

FIG. 5 illustrates a flowchart showing a method or methods that support managing partially programmed blocks in accordance with examples as disclosed herein.

### DETAILED DESCRIPTION

A memory system may store data in blocks that each include a set of pages, which may be accessible via a set of word lines. The pages may include memory cells that have threshold voltages that can be programmed in accordance with discrete threshold voltage levels (which may be referred to as logic states). In some examples, the actual values of the threshold voltage levels may vary between the memory cells, and distinct threshold voltage distributions may be used to represent the threshold voltage levels for a set of memory cells (e.g., in a block or page)—e.g., a first threshold voltage distribution may represent the range of actual threshold voltages of the set of memory cells when programmed at a first threshold voltage level, a second threshold voltage distribution may represent the range of actual threshold voltages of the set of memory cells when programmed at a second threshold voltage level. In some examples, the distance between the threshold voltage distributions (which may also be referred to as a “read window budget”) is associated with a performance of the memory system—e.g., a larger distance may be associated with improved bit error rates, lower latency, less power consumption, and the like.

In some examples, a block that is partially programmed (e.g., has one or more empty pages) may be invalidated before the block is fully programmed. In such cases, the invalidated block may remain in the partially programmed state until the block is erased e.g., which usually occurs when the block is selected to store new data.

A read window budget for a block that remains in a partially programmed state for an extended duration may be reduced relative to other blocks in a memory system, which may be referred to as “erase bake.” The period during which the block remains in the partially programmed state may be referred to as an erase bake period. To accommodate for the effects of an extended erase bake period on read window budget, a memory system may be operated as though all of the blocks have a degraded read window budget, which may reduce a performance of the memory system—e.g., may result in slower, more precise access operations, and/or increase power consumption from higher programming voltages. Accordingly, techniques for mitigating (e.g., eliminating) the reduction in read window budget for the memory system caused by erase bake conditions may be desired.

To mitigate the reduction in read window budget for a memory system caused by erase bake conditions, techniques may be used for ensuring that blocks of the memory system are in a fully programmed state after data invalidation. Such techniques will prevent blocks from resting in a partially programmed state—e.g., until a garbage collection operation is performed for the blocks.

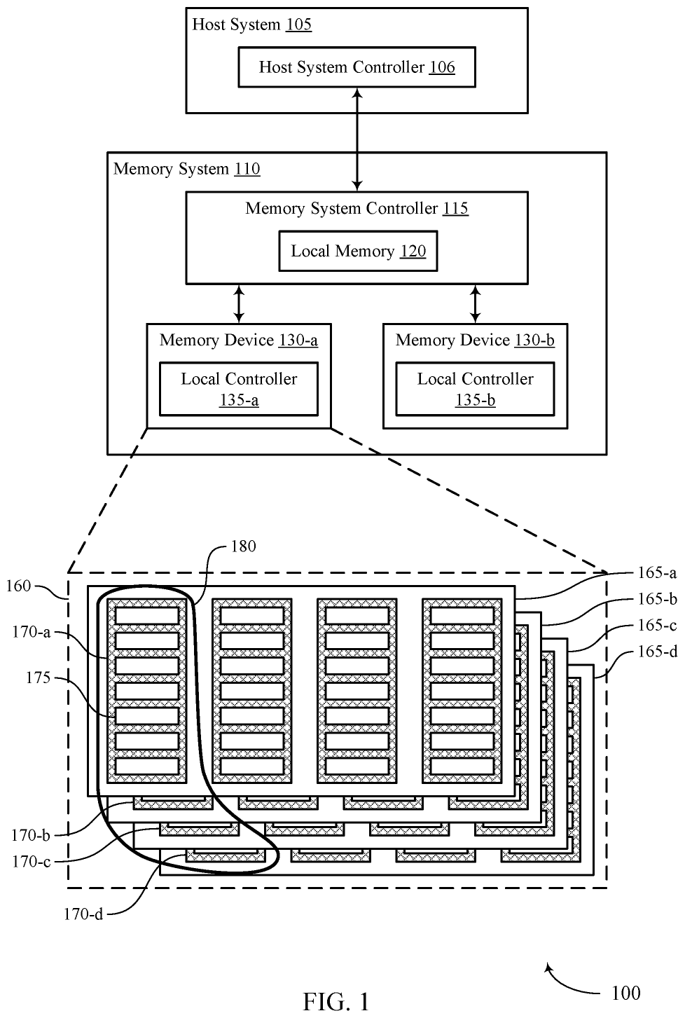

FIG. 1 illustrates an example of a system 100 that supports managing partially programmed blocks in accordance with examples as disclosed herein. The system 100 includes a host system 105 coupled with a memory system 110.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other possibilities.

The system 100 may be included in a computing device such as a desktop computer, a laptop computer, a network server, a mobile device, a vehicle (e.g., airplane, drone, train, automobile, or other conveyance), an Internet of Things (IoT) enabled device, an embedded computer (e.g., one included in a vehicle, industrial equipment, or a networked commercial device), or any other computing device that includes memory and a processing device.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset (e.g., one or more processors which may be part of or separate from one or more controllers) and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations—which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., logical block addresses (LBAs)) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (RAM) (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on a same die or within a same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170, and in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in a same page 175 may share (e.g., be coupled with) a common word line, and memory cells in a same string may share (e.g., be coupled with) a common digit line (which may alternatively be referred to as a bit line).

For some NAND architectures, memory cells may be read and programmed (e.g., written) at a first level of granularity (e.g., at the page level of granularity) but may be erased at a second level of granularity (e.g., at the block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

In some cases, a memory system 110 may utilize a memory system controller 115 to provide a managed memory system that may include, for example, one or more memory arrays and related circuitry combined with a local (e.g., on-die or in-package) controller (e.g., local controller 135). An example of a managed memory system is a managed NAND (MNAND) system.

The system 100 may include any quantity of non-transitory computer readable media that support managing partially programmed blocks. For example, the host system 105 (e.g., a host system controller 106), the memory system 110 (e.g., a memory system controller 115), or a memory device 130 (e.g., a local controller 135) may include or otherwise may access one or more non-transitory computer readable media storing instructions (e.g., firmware, logic, code) for performing the functions ascribed herein to the host system 105, the memory system 110, or a memory device 130. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

As described herein, the host system 105 may access data stored in the memory system 110. As part of accessing the data, the memory system 110 may access a page and/or block storing data addressed by the host system 105. To read the data stored in the page and/or block, the memory system 110 may determine and compare threshold voltages of NAND memory cells with one or more voltage levels to identify logic states of the NAND memory cells. In some examples, a cumulative distance (in voltage) between adjacent threshold voltage distributions may be referred to as a read window budget. In some examples, the larger the distance between adjacent threshold voltage distributions, the lower a bit error rate associated with accessing the NAND memory cells is.

As described herein, a block (e.g., the block 170) may include multiple pages (e.g., the page 175). In some examples, each of the pages may be accessed using a respective word line. During operation, subsets of the pages of the block 170 may be programmed at a time—e.g., the first two pages, then the third page, then the fourth page, and so on. In some examples, all of the pages of the block 170 may eventually be written—e.g., before the data in the block 170 is invalidated, as described herein. In other examples, only a subset of the pages in the block 170 may be written—e.g., before the data in the block 170 is invalidated. A block for which only a subset of the pages are written may be referred to as a partially programmed block. A block for which all of the pages are written may be referred to as a fully programmed block.

After the block 170 is invalidated, the block 170 may remain in the partially or fully programmed state (based on the quantity of programmed pages in the block 170) until a garbage collection operation is performed for the block 170. As described herein, the block 170 may in some examples be erased as a result of the garbage collection operation. In some examples, a garbage collection may not be performed for the block 170 for an extended duration (e.g., hours, days, months). For example, the garbage collection may not be performed until an available capacity of a memory system that includes the block 170 reaches a threshold.

A read window budget for a block that remains in a partially programmed state for an extended duration may be reduced relative to other blocks in the memory system 110 (e.g., a first read window budget for block x that remains in a partially programmed state for an extended duration may be reduced when compared to a second read window budget for block y that remains in a partially programmed state for the extended duration). The period during which the block remains in the partially programmed state may be referred to as an erase bake period. To accommodate for the effects of erase bake on read window budget, the memory system 110 may be operated as though all of the blocks have a degraded read window budget, which may reduce a performance of the memory system 110—e.g., may result in slower, more precise access operations, increase power consumption. Accordingly, techniques for mitigating (e.g., eliminating) the reduction in read window budget for the memory system 110 caused by erase bake conditions may be desired.

To mitigate the reduction in read window budget for the memory system 110 caused by erase bake conditions, techniques may be established for ensuring that blocks of the memory system 110 are in a fully programmed state after data invalidation. Such techniques may prevent blocks from resting in a partially programmed state until a garbage collection operation is performed for the blocks.

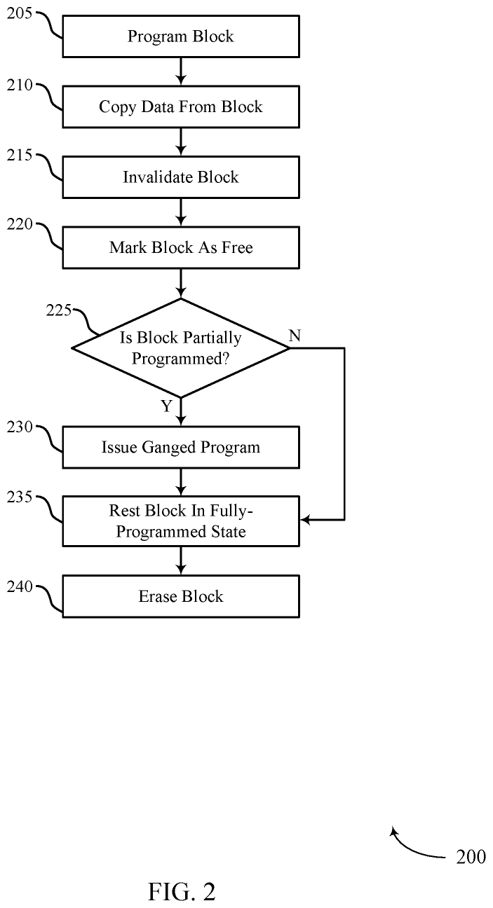

FIG. 2 illustrates an example of a set of operations for managing partially programmed blocks in accordance with examples as disclosed herein.

The flowchart 200 may be performed by a controller at a memory system described herein (e.g., the memory system controller 115, or a local controller 135 of FIG. 1). In some examples, the flowchart 200 shows an example set of operations performed to support managing partially programmed blocks. For example, the flowchart 200 may include operations for identifying a programming state (e.g., a partially or fully programmed state) for blocks that have been or are scheduled to be invalidated and for either maintaining fully programmed blocks in the fully programmed state or programming partially programmed blocks into the fully programmed state to ensure that blocks rest in a fully programmed state after invalidation.

At 205, a block may be programmed (e.g., by the controller) to store data. In some examples, based on storing the data, the block is in a partially programmed state—e.g., if one or more pages in the block remain unprogrammed after the data is stored. In some examples, based on storing the data, the block is in a fully programmed state—e.g., if all of the pages in the block are programmed after the data is stored.

At 210, data may be copied (e.g., by the controller) from the block to another block. In some examples, the data may be copied to another block as part of a data consolidation process. After the data is copied to the other block, the controller may respond to future requests for the data by accessing the other block.

At 215, the data stored in the block may be invalidated (e.g., by the memory controller) after the data is successfully copied to the other block.

At 220, the block may be marked (e.g., by the memory controller) as a free block. Marking the block as a free block may indicate that the block is available to store new data e.g., after first being erase.

At 225, a determination of whether the block is partially programmed or fully programmed may be made (e.g., by the memory controller). In some examples, the memory controller may determine whether the block is partially or fully programmed by reading a last page of the block. If reading the last page of the block indicates that the page has not been programmed, the memory controller may determine that the block is partially programmed. Otherwise, if reading the last page of the block indicates that the page has been programmed, the memory controller may determine that the block is fully programmed. In some examples, reading the last page of the block may indicate that the page has not been programmed if reading the page results in a predetermined data value (e.g., all 0s or all 1s). And reading the last page of the block may indicate that the page has been programmed if reading the page results in a data value that is different than the predetermined data value.

In some examples, the determination may be performed earlier—e.g., the determination may be made when the block is scheduled for invalidation, while the data is being copied from the block to the other block, once the block is invalidated.

If the controller determines that the block is in a partially programmed state, the controller may proceed to perform the operations described with reference to 230. Otherwise, the controller may proceed to perform the operations described with reference to 235.

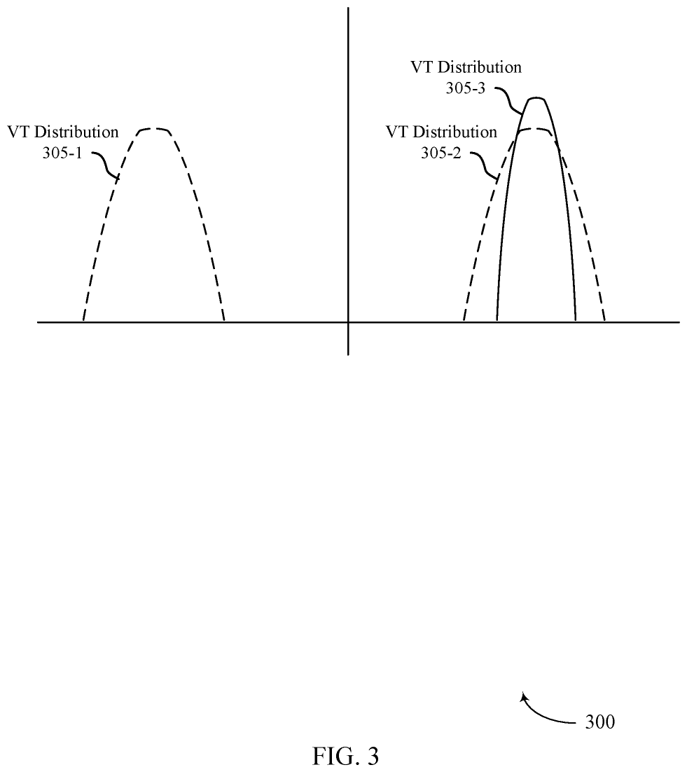

At 230, based on determining that the block is partially programmed, a ganged programming operation may be performed (e.g., by the controller). The ganged programming operation may result in a desired threshold voltage (VT) distribution for the block, as illustrated with reference to FIG. 3. In some examples, when the block has the desired VT distribution, each page in the block will be programmed. In some examples, the controller may identify trim parameters (e.g., a program verify voltage, a programming voltage, a pulse frequency, a pulse quantity, a pulse width, and the like) for applying to the word lines of the blocks in a memory system that results in the desired VT distribution. In some examples, the desired VT distribution is obtained by lowering the programming verify and programming voltages until the desired VT distribution is obtained.

In some examples, the ganged programming operation may result in a tighter VT distribution than may be achieved with other programming/erase operations (e.g., a pre-programming operation). A pre-programming operation may be performed to raise the threshold voltages of the memory cells to prevent over-erasure of the memory cells. In some examples, a pre-programming operation includes sequentially programing each or a subset of word lines in a block prior to an erase operation.

At 235, the block may be maintained in the fully-programmed state—e.g., by allowing the block to rest in the fully-programmed state. In some examples, the block is in the fully-programmed state as a result of the ganged programmed operation. In some examples, the block is configured into the fully-programmed state within a threshold duration (e.g., second or minutes) of the data in the block being invalidated. In some examples, the block is in the fully-programmed state based on all of the pages in the block being programmed during memory operation. The block may thus remain in the fully-programmed state until an erase operation is performed for the block—e.g., hours or days later.

At 240, the block may be erased (e.g., by the controller). In some examples, the block is erased based on the block being selected as a storage location for new data. In some examples, the block may be pre-programmed prior to the block being erased. The pre-programming operation may be similar to but performed for a different purpose than the ganged program. For example, the pre-programming operation may be performed to prevent a shallow erase condition for the block. In some examples, the VT distribution obtained by a pre-programming operation may be different than the VT distribution obtained by a ganged programming operation. For example, the VT distribution obtained by pre-programming may be wider than the VT distribution obtained by the ganged programming e.g., as a narrower VT distribution may more effectively mitigate the impact of an erase bake condition than a wider VT distribution. In some examples, the VT distribution obtained by pre-programming is greater than 10% wider than the VT distribution obtained by the ganged programming.

Aspects of the flowchart 200 may be implemented by a controller, among other components. Additionally, or alternatively, aspects of the flowchart 200 may be implemented as instructions stored in memory (e.g., firmware stored in a memory coupled with a controller). For example, the instructions, when executed by a controller, may cause the controller to perform the operations of the flowchart 200.

One or more of the operations described in the flowchart 200 may be performed earlier or later, omitted, replaced, supplemented, or combined with another operation. Also, additional operations described herein may replace, supplement or be combined with one or more of the operations described in the flowchart 200.

FIG. 3 illustrates an example of a diagram associated with managing partially programmed blocks in accordance with examples as disclosed herein.

The diagram 300 may illustrate different VT distributions for a block that is programmed using single cell programming techniques. The first voltage distribution 305-1 may indicate a distribution of threshold voltages for memory cells in a block that are programmed to have a first logic state (e.g., which may correspond to logic value 1). The second voltage distribution 305-2 may indicate a distribution of threshold voltages for memory cells in the block that are programmed to have a second logic state (e.g., which may correspond to logic value 0). The third voltage distribution 305-3 may indicate a distribution of threshold voltage for memory cells in the block that are programmed in a manner that is indicative of each page in the block being programmed. In some examples, the third voltage distribution 305-3 is obtained by modulating trim parameters for accessing the block, such as a programming voltage, a pulse frequency, a pulse quantity, a pulse width, and the like.

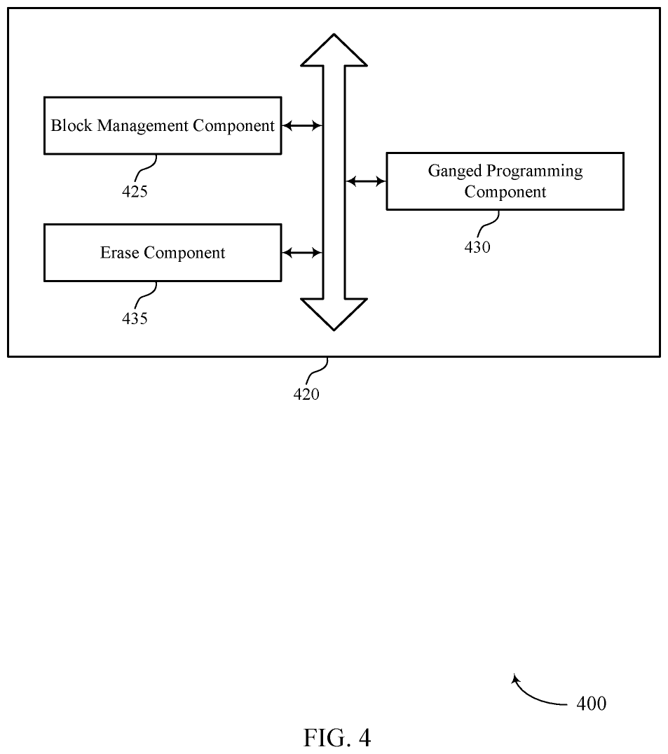

FIG. 4 illustrates a block diagram 400 of a memory system 420 that supports managing partially programmed blocks in accordance with examples as disclosed herein. The memory system 420 may be an example of aspects of a memory system as described with reference to FIGS. 1 through 3. The memory system 420, or various components thereof, may be an example of means for performing various aspects of managing partially programmed blocks as described herein. For example, the memory system 420 may include a block management component 425, a ganged programming component 430, an erase component 435, or any combination thereof. Each of these components may communicate, directly or indirectly, with one another (e.g., via one or more buses).

The block management component 425 may be configured as or otherwise support a means for writing data stored in a first block to a second block. The ganged programming component 430 may be configured as or otherwise support a means for determining, based least in part on writing the data stored in the first block to the second block, whether to program the first block into a fully programmed state based at least in part on whether the first block is storing the data in a partially programmed state. In some examples, the block management component 425 may be configured as or otherwise support a means for maintaining, based at least in part on determining whether to program the first block, the first block in the fully programmed state until an erase operation is performed for the first block. The erase component 435 may be configured as or otherwise support a means for performing the erase operation for the first block.

In some examples, the ganged programming component 430 may be configured as or otherwise support a means for determining whether the first block is storing the data in the partially programmed state, where determining whether the first block is storing the data in the partially programmed state includes. In some examples, the ganged programming component 430 may be configured as or otherwise support a means for reading a last page of the first block. In some examples, the ganged programming component 430 may be configured as or otherwise support a means for determining that the first block is storing the data in the partially programmed state based at least in part on the last page of the first block storing second data that indicates that the last page is in an erased state.

In some examples, the ganged programming component 430 may be configured as or otherwise support a means for determining that the first block is storing the data in the partially programmed state, where determining whether to program the first block includes determining to program the first block into the fully programmed state based at least in part on determining that the first block is storing the data in the partially programmed state.

In some examples, the ganged programming component 430 may be configured as or otherwise support a means for programming, based at least in part on determining to program the first block in the fully programmed state, the first block to store second data that causes the first block to be in the fully programmed state.

In some examples, the ganged programming component 430 may be configured as or otherwise support a means for programming, based at least in part on determining to program the first block in the fully programmed state, the first block to have a threshold voltage distribution within a threshold voltage window that corresponds to the fully programmed state.

In some examples, the block management component 425 may be configured as or otherwise support a means for determining that the first block is storing the data in the fully programmed state, where determining whether to program the first block includes determining to maintain the first block into the fully programmed state.

In some examples, the block management component 425 may be configured as or otherwise support a means for invalidating, based at least in part on writing the data to the second block, the data stored in the first block, where whether to program the first block into the fully programmed state is determined after the data stored in the first block is invalidated.

In some examples, the block management component 425 may be configured as or otherwise support a means for invalidating, based at least in part on writing the data to the second block, the data stored in the first block. In some examples, the block management component 425 may be configured as or otherwise support a means for designating the first block as free based at least in part on invalidating the data stored in the first block, where whether to program the first block into the fully programmed state is determined after the first block is designated as free.

In some examples, while in the partially programmed state, the first block includes a first set of pages that have been programmed and a second set of pages that are unprogrammed.

In some examples, the block management component 425 may be configured as or otherwise support a means for determining that the data stored in the first block is to be written to the second block, where whether to program the first block into the fully programmed state is determined after determining that the data is to be stored in the second block.

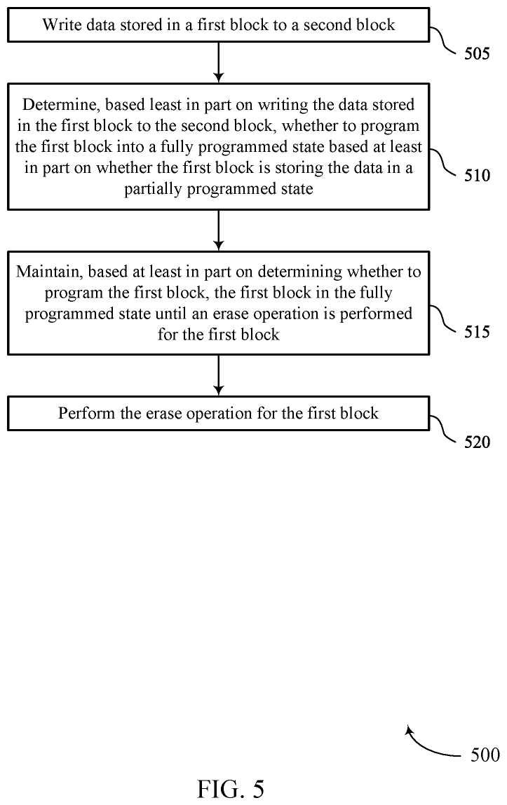

FIG. 5 illustrates a flowchart showing a method 500 that supports managing partially programmed blocks in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include writing data stored in a first block to a second block. The operations of 505 may be performed in accordance with examples as disclosed herein. In some examples, aspects of the operations of 505 may be performed by a block management component 425 as described with reference to FIG. 4.

At 510, the method may include determining, based least in part on writing the data stored in the first block to the second block, whether to program the first block into a fully programmed state based at least in part on whether the first block is storing the data in a partially programmed state. The operations of 510 may be performed in accordance with examples as disclosed herein. In some examples, aspects of the operations of 510 may be performed by a ganged programming component 430 as described with reference to FIG. 4.

At 515, the method may include maintaining, based at least in part on determining whether to program the first block, the first block in the fully programmed state until an erase operation is performed for the first block. The operations of 515 may be performed in accordance with examples as disclosed herein. In some examples, aspects of the operations of 515 may be performed by a block management component 425 as described with reference to FIG. 4.

At 520, the method may include performing the erase operation for the first block. The operations of 520 may be performed in accordance with examples as disclosed herein. In some examples, aspects of the operations of 520 may be performed by an erase component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by one or more processors), or any combination thereof for performing the following aspects of the present disclosure:

Aspect 1: A method, apparatus, or non-transitory computer-readable medium including operations, features, circuitry, logic, means, or instructions, or any combination thereof for writing data stored in a first block to a second block; determining, based least in part on writing the data stored in the first block to the second block, whether to program the first block into a fully programmed state based at least in part on whether the first block is storing the data in a partially programmed state; maintaining, based at least in part on determining whether to program the first block, the first block in the fully programmed state until an erase operation is performed for the first block; and performing the erase operation for the first block.

Aspect 2: The method, apparatus, or non-transitory computer-readable medium of aspect 1, further including operations, features, circuitry, logic, means, or instructions, or any combination thereof for determining whether the first block is storing the data in the partially programmed state, where determining whether the first block is storing the data in the partially programmed state includes; reading a last page of the first block; and determining that the first block is storing the data in the partially programmed state based at least in part on the last page of the first block storing second data that indicates that the last page is in an erased state.

Aspect 3: The method, apparatus, or non-transitory computer-readable medium of any of aspects 1 through 2, further including operations, features, circuitry, logic, means, or instructions, or any combination thereof for determining that the first block is storing the data in the partially programmed state, where determining whether to program the first block includes determining to program the first block into the fully programmed state based at least in part on determining that the first block is storing the data in the partially programmed state.

Aspect 4: The method, apparatus, or non-transitory computer-readable medium of aspect 3, further including operations, features, circuitry, logic, means, or instructions, or any combination thereof for programming, based at least in part on determining to program the first block in the fully programmed state, the first block to store second data that causes the first block to be in the fully programmed state.

Aspect 5: The method, apparatus, or non-transitory computer-readable medium of any of aspects 3 through 4, further including operations, features, circuitry, logic, means, or instructions, or any combination thereof for programming, based at least in part on determining to program the first block in the fully programmed state, the first block to have a threshold voltage distribution within a threshold voltage window that corresponds to the fully programmed state.

Aspect 6: The method, apparatus, or non-transitory computer-readable medium of any of aspects 1 through 5, further including operations, features, circuitry, logic, means, or instructions, or any combination thereof for determining that the first block is storing the data in the fully programmed state, where determining whether to program the first block includes determining to maintain the first block into the fully programmed state.

Aspect 7: The method, apparatus, or non-transitory computer-readable medium of any of aspects 1 through 6, further including operations, features, circuitry, logic, means, or instructions, or any combination thereof for invalidating, based at least in part on writing the data to the second block, the data stored in the first block, where whether to program the first block into the fully programmed state is determined after the data stored in the first block is invalidated.

Aspect 8: The method, apparatus, or non-transitory computer-readable medium of any of aspects 1 through 7, further including operations, features, circuitry, logic, means, or instructions, or any combination thereof for invalidating, based at least in part on writing the data to the second block, the data stored in the first block and designating the first block as free based at least in part on invalidating the data stored in the first block, where whether to program the first block into the fully programmed state is determined after the first block is designated as free.

Aspect 9: The method, apparatus, or non-transitory computer-readable medium of any of aspects 1 through 8, where while in the partially programmed state, the first block includes a first set of pages that have been programmed and a second set of pages that are unprogrammed.

Aspect 10: The method, apparatus, or non-transitory computer-readable medium of any of aspects 1 through 9, further including operations, features, circuitry, logic, means, or instructions, or any combination thereof for determining that the data stored in the first block is to be written to the second block, where whether to program the first block into the fully programmed state is determined after determining that the data is to be stored in the second block.

It should be noted that the described techniques include possible implementations, and that the operations and the steps may be rearranged or otherwise modified and that other implementations are possible. Further, portions from two or more of the methods may be combined.

An apparatus is described. The following provides an overview of aspects of the apparatus as described herein:

Aspect 11: An apparatus, including: one or more controllers and/or processors; and one or more memory devices coupled with the one or more controllers and/or processors, the one or more memory devices storing instructions executable by the one or more controllers and/or processors to cause the apparatus to: write data stored in a first block to a second block; determine, based least in part on writing the data stored in the first block to the second block, whether to program the first block into a fully programmed state based at least in part on whether the first block is storing the data in a partially programmed state; maintain, based at least in part on determining whether to program the first block, the first block in the fully programmed state until an erase operation is performed for the first block; and perform the erase operation for the first block.

Aspect 12: The apparatus of aspect 11, where the instructions are further executable by the one or more controllers and/or processors to cause the apparatus to: determine whether the first block is storing the data in the partially programmed state, where the instructions for determining whether the first block is storing the data in the partially programmed state are further executable by the one or more controllers and/or processors to cause the apparatus to: read a last page of the first block; and determine that the first block is storing the data in the partially programmed state based at least in part on the last page of the first block storing second data that indicates that the last page is in an erased state.

Aspect 13: The apparatus of any of aspects 11 through 12, where the instructions are further executable by the one or more controllers and/or processors to cause the apparatus to: determine that the first block is storing the data in the partially programmed state, where the instructions for determining whether to program the first block are further executable by the one or more controllers and/or processors to cause the apparatus to determine to program the first block into the fully programmed state based at least in part on determining that the first block is storing the data in the partially programmed state.

Aspect 14: The apparatus of aspect 13, where the instructions are further executable by the one or more controllers and/or processors to cause the apparatus to: program, based at least in part on determining to program the first block in the fully programmed state, the first block to store second data that causes the first block to be in the fully programmed state.

Aspect 15: The apparatus of any of aspects 13 through 14, where the instructions are further executable by the one or more controllers and/or processors to cause the apparatus to: program, based at least in part on determining to program the first block in the fully programmed state, the first block to have a threshold voltage distribution within a threshold voltage window that corresponds to the fully programmed state.

Aspect 16: The apparatus of any of aspects 11 through 15, where the instructions are further executable by the one or more controllers and/or processors to cause the apparatus to: determine that the first block is storing the data in the fully programmed state, where the instructions for determining whether to program the first block are further executable by the one or more controllers and/or processors to cause the apparatus to determine to maintain the first block into the fully programmed state.

Aspect 17: The apparatus of any of aspects 11 through 16, where the instructions are further executable by the one or more controllers and/or processors to cause the apparatus to: invalidate, based at least in part on writing the data to the second block, the data stored in the first block, where whether to program the first block into the fully programmed state is determined after the data stored in the first block is invalidated.

An apparatus is described. The following provides an overview of aspects of the apparatus as described herein:

Aspect 18: A non-transitory, computer-readable medium storing code including instructions executable by a one or more controllers and/or processors of an electronic device to cause the electronic device to: write data stored in a first block to a second block; determine, based least in part on writing the data stored in the first block to the second block, whether to program the first block into a fully programmed state based at least in part on whether the first block is storing the data in a partially programmed state; maintain, based at least in part on determining whether to program the first block, the first block in the fully programmed state until an erase operation is performed for the first block; and perform the erase operation for the first block.

Aspect 19: The non-transitory, computer-readable medium of aspect 18, where the instructions are further executable by the one or more controllers and/or processors to cause the electronic device to: determine whether the first block is storing the data in the partially programmed state, where the instructions for determining whether the first block is storing the data in the partially programmed state are further executable by the one or more controllers and/or processors to cause the electronic device to: read a last page of the first block; and determine that the first block is storing the data in the partially programmed state based at least in part on the last page of the first block storing second data that indicates that the last page is in an erased state.

Aspect 20: The non-transitory, computer-readable medium of any of aspects 18 through 19, where the instructions are further executable by the one or more controllers and/or processors to cause the electronic device to: determine that the first block is storing the data in the partially programmed state, where the instructions for determining whether to program the first block are further executable by the one or more controllers and/or processors to cause the electronic device to determine to program the first block into the fully programmed state based at least in part on determining that the first block is storing the data in the partially programmed state.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit based on the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

As used herein, the term “substantially” means that the modified characteristic (e.g., a verb or adjective modified by the term substantially) need not be absolute but is close enough to achieve the advantages of the characteristic.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed and second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed and second condition or action may occur directly as a result of the previous condition or action occurring independent of whether other conditions or actions occur. In some examples, a first condition or action may be performed and second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorous, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by one or more controllers and/or processors, firmware, or any combination thereof. If implemented in software executed by one or more controllers and/or processors, the functions may be stored on or transmitted over, as one or more instructions or code, a computer-readable medium. Other examples and implementations are within the scope of the disclosure and appended claims. For example, due to the nature of software, the described functions can be implemented using software executed by one or more controllers, processors, hardware, firmware, hardwiring, or combinations of any of these. Features implementing functions may also be physically located at various positions, including being distributed such that portions of functions are implemented at different physical locations.

For example, the various illustrative blocks and components described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor or one or more processors may be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk, and Blu-ray disc, where disks usually reproduce data magnetically, while discs reproduce data optically with lasers. Combinations of these are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
writing data stored in a first block to a second block;
determining, based least in part on writing the data stored in the first block to the second block, whether to program the first block into a fully programmed state based at least in part on whether the first block is storing the data in a partially programmed state;
maintaining, based at least in part on determining whether to program the first block, the first block in the fully programmed state until an erase operation is performed for the first block; and
performing the erase operation for the first block.

2. The method of claim 1, further comprising:
determining whether the first block is storing the data in the partially programmed state, wherein determining whether the first block is storing the data in the partially programmed state comprises:
reading a last page of the first block; and
determining that the first block is storing the data in the partially programmed state based at least in part on the last page of the first block storing second data that indicates that the last page is in an erased state.

3. The method of claim 1, further comprising:
determining that the first block is storing the data in the partially programmed state, wherein determining whether to program the first block comprises determining to program the first block into the fully programmed state based at least in part on determining that the first block is storing the data in the partially programmed state.

4. The method of claim 3, further comprising:
programming, based at least in part on determining to program the first block in the fully programmed state, the first block to store second data that causes the first block to be in the fully programmed state.

5. The method of claim 3, further comprising:
programming, based at least in part on determining to program the first block in the fully programmed state, the first block to have a threshold voltage distribution within a threshold voltage window that corresponds to the fully programmed state.

6. The method of claim 1, further comprising:
determining that the first block is storing the data in the fully programmed state, wherein determining whether to program the first block comprises determining to maintain the first block into the fully programmed state.

7. The method of claim 1, further comprising:
invalidating, based at least in part on writing the data to the second block, the data stored in the first block, wherein whether to program the first block into the fully programmed state is determined after the data stored in the first block is invalidated.

8. The method of claim 1, further comprising:
invalidating, based at least in part on writing the data to the second block, the data stored in the first block; and
designating the first block as free based at least in part on invalidating the data stored in the first block, wherein whether to program the first block into the fully programmed state is determined after the first block is designated as free.

9. The method of claim 1, wherein, while in the partially programmed state, the first block comprises a first set of pages that have been programmed and a second set of pages that are unprogrammed.

10. The method of claim 1, further comprising:
determining that the data stored in the first block is to be written to the second block, wherein whether to program the first block into the fully programmed state is determined after determining that the data is to be stored in the second block.

11. An apparatus, comprising:
one or more controllers; and
one or more memory devices coupled with the one or more controllers, the one or more memory devices storing instructions executable by the one or more controllers to cause the apparatus to:
write data stored in a first block to a second block;
determine, based least in part on writing the data stored in the first block to the second block, whether to program the first block into a fully programmed state based at least in part on whether the first block is storing the data in a partially programmed state;
maintain, based at least in part on determining whether to program the first block, the first block in the fully programmed state until an erase operation is performed for the first block; and
perform the erase operation for the first block.

12. The apparatus of claim 11, wherein the instructions are further executable by the one or more controllers to cause the apparatus to:
determine whether the first block is storing the data in the partially programmed state, wherein the instructions for determining whether the first block is storing the data in the partially programmed state are further executable by the one or more controllers to cause the apparatus to:
read a last page of the first block; and
determine that the first block is storing the data in the partially programmed state based at least in part on the last page of the first block storing second data that indicates that the last page is in an erased state.

13. The apparatus of claim 11, wherein the instructions are further executable by the one or more controllers to cause the apparatus to:
determine that the first block is storing the data in the partially programmed state, wherein the instructions for determining whether to program the first block are further executable by the one or more controllers to cause the apparatus to determine to program the first block into the fully programmed state based at least in part on determining that the first block is storing the data in the partially programmed state.

14. The apparatus of claim 13, wherein the instructions are further executable by the one or more controllers to cause the apparatus to:
program, based at least in part on determining to program the first block in the fully programmed state, the first block to store second data that causes the first block to be in the fully programmed state.

15. The apparatus of claim 13, wherein the instructions are further executable by the one or more controllers to cause the apparatus to:
program, based at least in part on determining to program the first block in the fully programmed state, the first block to have a threshold voltage distribution within a threshold voltage window that corresponds to the fully programmed state.

16. The apparatus of claim 11, wherein the instructions are further executable by the one or more controllers to cause the apparatus to:
determine that the first block is storing the data in the fully programmed state, wherein the instructions for determining whether to program the first block are further executable by the one or more controllers to cause the apparatus to determine to maintain the first block into the fully programmed state.

17. The apparatus of claim 11, wherein the instructions are further executable by the one or more controllers to cause the apparatus to:
invalidate, based at least in part on writing the data to the second block, the data stored in the first block, wherein whether to program the first block into the fully programmed state is determined after the data stored in the first block is invalidated.

18. A non-transitory, computer-readable medium storing code comprising instructions executable by one or more processors of an electronic device to cause the electronic device to:
write data stored in a first block to a second block;
determine, based least in part on writing the data stored in the first block to the second block, whether to program the first block into a fully programmed state based at least in part on whether the first block is storing the data in a partially programmed state;
maintain, based at least in part on determining whether to program the first block, the first block in the fully programmed state until an erase operation is performed for the first block; and
perform the erase operation for the first block.

19. The non-transitory, computer-readable medium of claim 18, wherein the instructions are further executable by the one or more processors to cause the electronic device to:
determine whether the first block is storing the data in the partially programmed state, wherein the instructions for determining whether the first block is storing the data in the partially programmed state are further executable by the one or more processors to cause the electronic device to:
read a last page of the first block; and
determine that the first block is storing the data in the partially programmed state based at least in part on the last page of the first block storing second data that indicates that the last page is in an erased state.

20. The non-transitory, computer-readable medium of claim 18, wherein the instructions are further executable by the one or more processors to cause the electronic device to:
determine that the first block is storing the data in the partially programmed state, wherein the instructions for determining whether to program the first block are further executable by the one or more processors to cause the electronic device to determine to program the first block into the fully programmed state based at least in part on determining that the first block is storing the data in the partially programmed state.
